(19) United States
(12) Patent Application Publication
(10) Pub. No.: US 2024/0424766 A1
(43) Pub. Date: Dec. 26, 2024

(54) GLAZING WITH INSERT

(71) Applicant: AGC GLASS EUROPE, Louvain-la-Neuve (BE)

(72) Inventors: Sacha REMACLE, Gosselies (BE); Robert HICK, Gosselies (BE); Günther SALME, Gosselies (BE); Xavier DARDENNE, Gosselies (BE)

(73) Assignee: AGC GLASS EUROPE, Louvain-la-Neuve (BE)

(21) Appl. No.: 18/685,399

(22) PCT Filed: Oct. 13, 2022
(86) PCT No.: PCT/EP2022/078591

§ 371 Date: Feb. 21, 2024

(30) Foreign Application Priority Data
Oct. 14, 2021 (EP) 21202708.0
Dec. 30, 2021 (EP) 21218422.0

(51) Int. Cl. B32B 17/10

(52) U.S. Cl. CPC B32B 17/10293; B32B 17/10036; B32B 17/10339; B32B 17/1077; B32B 17/10807; B32B 2307/7265; B32B 2605/00

(57) ABSTRACT

A glazing (100) includes a main body (110) having an outer surface (112), an inner surface (114) arranged opposite to the outer surface (116) and an edge defining a cut-out (126) extending from the outer surface (112) to the inner surface (114) of the main body (110). The glazing (100) also includes an insert (140) having a shape of the cut-out (126), the insert (140) being coupled to the main body (110) and arranged inside the cut-out (126), wherein at least an outer (142) surface of the insert (140) is flush with the outer surface (112) of the main body (110).

### TECHNICAL FIELD

The present disclosure relates, generally, to a glazing. More particularly, the present disclosure relates to a glazing having a main body and an insert coupled to the main body and suitable to facilitate an easy integration of various sensors to the glazing.

### BACKGROUND

Modern vehicles are usually equipped with sensors for traffic monitoring, which, for example, recognize road signs or the position and speed of objects around the vehicle, such as road users or obstacles on the road. Currently, primarily optical cameras, radar systems or Lidar systems are used for this purpose and are generally mounted behind the windshield of the vehicle, or within the bumper. However, an integration of such sensors on the windshield adds to the complexity of the manufacturing of the windshield. Moreover, to enhance and improve the viewing capabilities of such sensors, various anti-reflective coatings and water repellent coatings may be applied on the interior and/or exterior surfaces of the windshield, thereby increasing cost of the windshield, which is not desirable.

### SUMMARY

It is therefore a first aspect of the current disclosure to provide a glazing that facilitates a seamless integration of various sensors, such as, but not limited to, vision sensors, infra-red sensors, environmental sensors, etc., to the glazing while reducing the cost of the glazing.

Thus, the present invention concerns a glazing comprises a main body having an outer surface, an inner surface arranged opposite to the outer surface and an edge defining a cut-out extending from the outer surface to the inner surface of the main body. The glazing also includes an insert having the shape cut-out and more particularly the same shape of the cut-out. The insert is coupled to the main body and is arranged inside the cut-out. At least an outer surface of the insert is flush with the outer surface of the main body.

An aspect is to provide a glazing made of two components to reduce overall cost of the glazing.

Another aspect is to concentrate the added value onto the insert part as it is easier to do it on a small piece of glass rather than a big piece of glass.

At least some of the above-mentioned issues are solved by a glazing as described in claim 1.

### DESCRIPTION

Thus, the present invention concerns a glazing comprising a main body having an outer surface, an inner surface arranged opposite to the outer surface and an edge defining a cut-out extending from the outer surface to the inner surface of the main body. The glazing also includes an insert having a shape of the cut-out. The insert is coupled to the main body and is arranged inside the cut-out. At least an outer surface of the insert is flush with the outer surface of the main body.

The insert expected to carry on the sensors (camera, Lidar, IR-sensors, rain and light sensors . . . ) but also the mirror button, is thus dissociated from the rest of the glazing allowing more easy handling of this part, in term of application of coating, black band for protection and aesthetic point of view.

According to an embodiment of the present invention, a flush mechanical junction is provided between the insert and the rest of the glazing.

In some embodiments, an inner surface of the insert is flush with the inner surface of the main body.

For mechanical and aesthetic reasons, the inner and the outer surfaces of the insert are flush with the inner and outer surfaces of the main body.

According to another advantageous embodiment of the invention, the glazing has a water repellent layer arranged only on the insert.

According to another advantageous embodiment of the invention, the insert may be coated with a hydrophobic layer that prevents water droplets to aggregate onto the insert outer surface in order to ensure proper sensor operation during rainy conditions. Such water repellant coating can be, for example, composed of thin molecular layers of fluoropolymers that reduces the surface energy and provides self-cleanability, anti-stain properties and improved moisture resistance among other effects.

Thus, by locating the water repellent layer only on the insert, the optical distortion over the glazing and the cost to produce a glazing comprising such insert are better controlled.

Another embodiment of the present invention is to provide a glazing having an anti-reflective layer arranged/deposed only on the insert. In some embodiments, the glazing includes an anti-reflective layer arranged on the inner surface of the insert. It is understood that the anti-reflective layer may be arranged on the outer surface of the insert.

An antireflective layer according to the invention may, for example, be a layer based on porous silica having a low refractive index or it may be composed of several layers (stack), in particular a stack of layers of dielectric material alternating layers having low and high refractive indexes and terminating in a layer having a low refractive index. Such coating may be provided on the outer and/or inner face of the insert. A textured glass sheet may be also as a part of the insert. Etching or coating techniques may as well be used in order to avoid reflection. Preferably, the reflection of the treated surface would decrease from at least 1% and preferably from at least 2% if both surfaces are coated, within the concerned wavelength range.

According to another embodiment of the invention, an antireflective layer according to the invention may, for example, be a layer based on refractive index gradient layer deposited for example by ion implantation technique. According to another embodiment of the invention, a combination of the above cited antireflective layers may be provided on the external and/or internal face of the cover lens. Preferably, the layers are deposited by PVD (soft coating). Thus, it may be possible to have a reflective coating in visible range, which also presents anti-reflective capability in IR range. As for the water repellent, the location of the layer only on the insert allows to have a better optical performance.

Other suitable advantageous functionalities can be added to the glass sheet of the insert of the invention, in particular to provide supporting functions to further enhance the good operation of the sensor. Those supporting functions can be for example: the coupling with integrated detection functions for breakage, dirt, stain, rain, . . . or additional protection layers for preventing scratches, glare, stain, dirt, paint, . . . Dedicated filters could also be integrated for polarization, phase or spectral discrimination.

According to another advantageous embodiment of the invention, the insert may be coupled with a heating system that allows the insert to quickly defrost or defog when the external operating conditions are unfavorable. Such heating system can be composed of a network of conductive wires, conductive patch or alternatively a silver print network directly applied on the insert surface where an adequate power supply can be applied. Optionally, the system can also comprise a temperature sensor for dynamically triggering and controlling the heating function in case of need.

According to an advantageous embodiment of the invention, the glass sheet can be coated with at least one IR transparent absorbing (tinted) and/or reflecting coating in order to hide the un-aesthetic element of the sensor from the outside while ensuring a good level of operating performances. This coating may, for example, be composed of at least one layer of a black film or a layer of black paint having no (or very low) transmission in the visible optical range but having a high transparency in the infrared range of interest for the application.

According to an embodiment of the present invention, the glazing has a black print arranged on an insert of the glazing that is arranged facing the various sensors. The masking (and protection) of sensors, glue . . . is generally made by using a black band such as black enamel, black paint, black interlayer. . . . Generally, the black band is applied during the process of manufacturing of the glazing. In case of windshield, the black band may lead to optical distortion and particularly in the place wherein the sensors are expected to be applied.

In some embodiments, the glazing and more particularly an automotive glazing includes a black print arranged on the insert.

In some embodiments, the black print is arranged on the inner or/and the surface of the insert.

Thus, thanks to the present invention, the insert may be handled independently form the rest of the glazing leading to better control the optical distortion in this area and/or to enhance optical performance and also to applied some functionalities such antireflective, water repellent, . . . functionalities only in the required area ie the zone wherein the sensors will be present.

According to a preferred embodiment of the present invention, the glazing is an automotive glazing.

According to another preferred embodiment of the present invention, the glazing is a windshield.

In some embodiments, the insert is made of a laminated glass having a first glass layer and a second glass layer arranged facing each other and the black print is arranged between the first glass layer and the second glass layer. The laminated insert is particularly useful when it is part of an automotive glazing and more particularly is part of windshield. The windshield being a laminated glazing, the insert has preferably the same thickness of the main body. The insert has preferably the same composition in term of insert material and the interlayer used to laminate the insert. However, the insert may be made of different material. The insert may be a laminate of a first glass sheet and a plastic material. The cost of the laminated insert may be reduced.

In some embodiments, the black print defines at least one opening defining at least one transparent zone for at least one sensor. As for common automotive glazing, a black print is provided at the periphery of the windshield and in the zone wherein at least one sensor is provided, also called “the camera zone”. The black print in the camera zone is provided with opening for the field of view of the sensor allowing the camera to see in the visible range.

In some embodiments, a bracket is mounted to the insert to support at least one sensor and arranged facing the inner surface of the insert.

The bracket may help to maintain and/or to insure the sealing between the insert and the main body of the glazing. Indeed, in the case of a windshield, the bracket expected to support at least one support may be mechanically fixed to the insert.

In some embodiments, the insert is made of an infrared transparent glass.

According to the invention, the glass sheet is made of glass which may belong to different categories with the particularity of having an absorption coefficient lower than 15 m-1 in the wavelength range from 750 to 1650 nm. The glass can thus be a soda-lime-silica type glass, alumino-silicate, boro-silicate, . . .

Preferably, the glass sheet having a high level of near infrared radiation transmission is an extra-clear glass.

Preferably, the base glass composition of the invention comprises a total content expressed in weight percentages of glass:

| | |
|---|---|
| SiO2 | 55-85% |
| Al2O3 | 0-30% |
| B2O3 | 0-20% |
| Na2O | 0-25% |
| CaO | 0-20% |
| MgO | 0-15% |
| K2O | 0-20% |
| BaO | 0-20%. |

In some embodiments, infrared (IR) energy transmissions of the insert and the main body differ by more than 20%. The IR transmittance is an important parameter for sensors placed behind a glazing and in particular behind an insert. Thus, the insert have a preferably a higher IR energy transmission (also called IR transmittance) than the main body.

In some embodiments, insert is adhesively coupled to the main body. For example, the insert may be coupled to the main body thanks for example to a material made of polyurethane or silicone. The junction material is then for example injected between the insert and the main body to fix the 2 parts (insert and main body) together.

In some embodiment, an adhesive to couple the insert with the main body is made of a damping material. The damping material may be a gluing material that is soft enough to absorb vibration. The damping material may be silicone or material having same properties such as viscoelasticity.

In some embodiments, the insert is coupled to the main body by injecting a thermoplastic elastomer at a junction of the insert and the main body. Thus, the thermoplastic elastomer ensures the junction of the insert and the main body while insuring the sealing too.

In some embodiments, the edge is a first edge of the main body adapted to be arranged proximate to and along a roof of the vehicle, and the cut-out is defined substantially centrally to the first edge, wherein the insert is adapted to support a rear-view mirror of the vehicle.

A method for manufacturing a windshield is disclosed according to an aspect of the disclosure. The method includes positioning an insert inside a cut-out of a main body such that an outer surface of the insert is flush with an outer surface of the main body, wherein the cut-out is defined by an edge of the main body and extends from the outer surface of the main body to an inner surface of the main body. The method further includes coupling the insert to the main body.

In some embodiments, coupling the insert to the main body includes applying adhesive at a junction of the insert and the main body to adhesively couple the insert with the main body.

In some embodiments, coupling the insert of the main body includes injection moulding a thermoplastic elastomer at a junction of the insert and the main body.

In some embodiments, the method further includes mounting a bracket to the insert such that the bracket is arranged facing an inner surface of the insert.

In some embodiments, mounting the bracket includes positioning an end of the bracket along a junction of the insert and the main body and coupling the end of the bracket to the junction. Thus, the bracket ensures its role of supporting the sensors and ensures also a role of sealing and the stability of the assembly is enhanced.

According to one embodiment of the present, the bracket is mounted by positioning an end of the bracket along a junction of the insert and the main body and coupling the end of the bracket to the junction, the end of the bracket overlapping the junction and a part of the main body.

According to a preferred embodiment of the present invention, an end of the bracket extends from 5 to 10 mm over the main body in order to increase the strengthen of the junction between the insert and the main body.

More preferably, the end of the bracket in contact with the main body comprises a recess wherein for example a thermoplastic material and more particularly a thermoplastic elastomer material is injected to reach to a soft connection between the insert, the main body and the bracket. It is understood that any material leading to this “soft connection” may be used.

It should be emphasized that the term “comprises/comprising/comprised of” when used in this specification is taken to specify the presence of stated features, integers, steps, or components but does not preclude the presence or addition of one or more other features, integers, steps, components, or groups thereof.

### BRIEF DESCRIPTION OF THE DRAWINGS

In the following, the disclosure will be described in greater detail with reference to embodiments shown by the enclosed figures. It should be emphasized that the embodiments shown are used for example purposes only and should not be used to limit the scope of the disclosure.

FIG. 1 shows a sectional view of a glazing as a windshield mounted to a vehicle.

FIG. 2 shows an exploded view of the windshield of FIG. 1 depicting an insert separated from a main body.

FIG. 3 shows an assembled view of the windshield of FIG. 1 depicting the insert arranged inside a cut-out of the main body.

FIG. 4 shows an enlarged view of a portion of the windshield depicting a black print arranged on an inner surface of the insert and defining at least one opening.

FIG. 5 shows a sectional view of the insert depicting various layers of the insert.

FIG. 6 shows a schematic 3D view of a glazing as a windshield mounted with a bracket according to one embodiment of the present invention to a vehicle.

FIG. 7 shows a sectional view of a glazing as a windshield mounted with a bracket according to one embodiment of the resent invention to a vehicle.

### DETAILED DESCRIPTION OF THE EMBODIMENTS

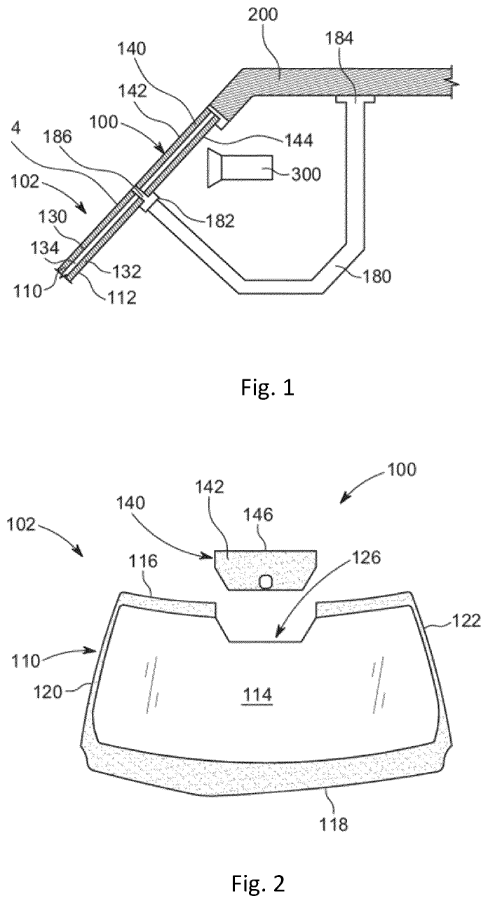

Referring to FIG. 1, a glazing 100 as a windshield 102 attached to a body 200 of a vehicle is shown. Although, the glazing 100 is shown and contemplated as the windshield 102, it may be appreciated that the glazing 100 may be used as a window of the vehicle, a window of a building, and like. The glazing 100 may also include backlites, side-lites, and panoramic roofs of a vehicle, a construction machine, an earthmoving machine, etc.

As illustrated in FIG. 1 and FIG. 2, the windshield 102 includes a main body 110 having an inner surface 112 arranged facing an interior of the vehicle, and an outer surface 114 disposed opposite to the inner surface 112 and arranged facing an exterior of the vehicle. Further, the main body 110 includes an upper edge 116, a lower edge 118 disposed opposite to the upper edge 116, and a pair of side edges 120, 122 extending from the upper edge 116 to the lower edge 118 and arranged spaced apart and facing each other. An edge, for example, the upper edge 116 of the main body 110 defines a cut-out 126 extending from the outer surface 114 to the inner surface 112 of the main body 110 and located substantially centrally in a lateral direction of the windshield 102.

In an embodiment, the main body 110 may include a laminated glass having a first glass layer 130 (i.e., an outer glass layer 130) defining the outer surface 114 of the main body 110, a second glass layer 132 (i.e., an inner glass layer 132) defining the inner surface 112 of the main body 110, and intermediate layer 134 sandwiched between the first glass layer 130 and the second glass layer 132 and made of a plastic. In an embodiment, the intermediate layer 134 is a vinyl layer. Although, the main body 110 made of laminated glass is shown and contemplated, it may be envisioned that the main body 110 may be made of toughened glass, tempered glass, or any other suitable glass known in the art. It may be appreciated that the main body 110 is made of a transparent material and the type of transparent material, such as, glass, may depend on the application or area in which the glazing 100 is utilized.

Additionally, the windshield 102 (i.e., glazing 100) includes an insert 140 arranged inside the cut-out 126 of the main body 110 and coupled to the main body 110. The insert 140 may be adhesively coupled to the main body 110. In an embodiment, the adhesive 400 may be hot glue, a singe face adhesive tape or a double face adhesive tape. The adhesive 400 may include vibration damping material. In some embodiments, the insert 140 may be coupled to the main body 110 by injection moulding a thermoplastic elastomer at a junction of the insert and the main body 110. In some embodiments, the thermoplastic elastomer may be polyurethane. As shown in FIG. 1, an outer surface 142 of the insert 140 is flush with the outer surface 114 of the main body 110 and an inner surface 144 of insert 140 is flush with the inner surface 112 of the main body 110. In some embodiments, only the outer surface 142 of the insert 140 may be flush with the outer surface 114 of the main body 110. Accordingly, the outer surface 114 of the main body 110 and the outer surface 142 of the insert 140 together define an outer surface of the windshield 102, while the inner surface 144 of the insert 140 and the inner surface 112 of the main body 110 together define an inner surface of the windshield 102. Also, the upper edge 116 of the main body 110 and an upper edge 146 of the insert 140 together define an upper edge of the windshield 102 that is arranged proximate to a roof of the vehicle and may be attached to the roof of the vehicle. Moreover, the side edges 120, 122 of the main body 200 are connected to the two pillars of the vehicle.

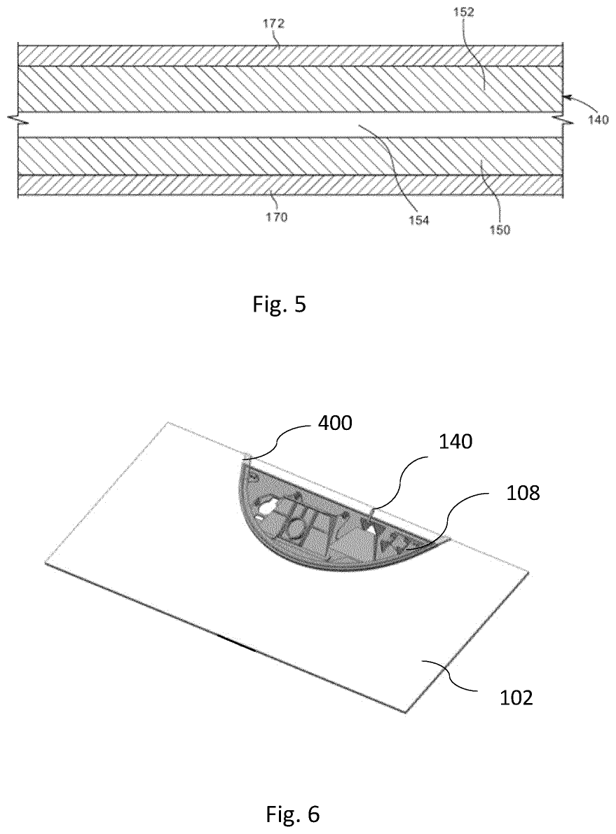

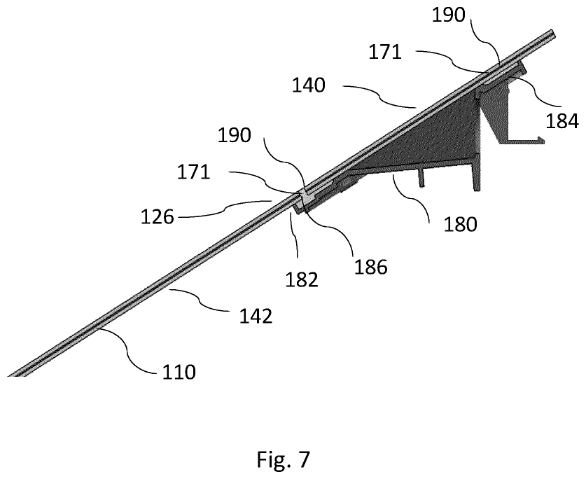

In the illustrated embodiment, as best shown in FIGS. 1 and 5, the insert 140 is made of a laminated glass having an inner glass layer 150, an outer glass layer 152, and an intermediate plastic layer 154 sandwiched arranged between the outer glass layer 152 and the inner glass layer 150. Although the insert 140 made of laminated glass is contemplated, the insert 140 may be made of any other glass, such as, but not limited to, tempered glass, toughened glass, or any other suitable glass based on the application area of the glazing 100. For example, in an embodiment, when the glazing 100 is used for a window a building, the insert 140 may be made of toughened glass. In some embodiment, the insert 140 may made of a transparent material other than glass, such as, but not limited to, polycarbonate. It may be appreciated that the insert 140 may made of a material different than a material of the main body 110. In such a case, the insert 140 and the main body 110 are selected such that the difference between the thermal expansions between the materials of the insert 140 and the main body 110 is within an allowable limit. In an embodiment, the insert 140 may be made of an infrared transparent glass. In some embodiments, an infrared optical transmission of the insert 140 may differ from an infrared optical transmission of the main body 110 by more than 20%. In some embodiments, the infrared optical transmission of the insert 140 is more than 20% of the infrared optical transmission of the main body 110. Also, in the illustrated embodiment, a location of the insert 140 and hence the cut-out 126 is chosen/selected that corresponds to a location of mounting of a rear-view mirror on the windshield 102.

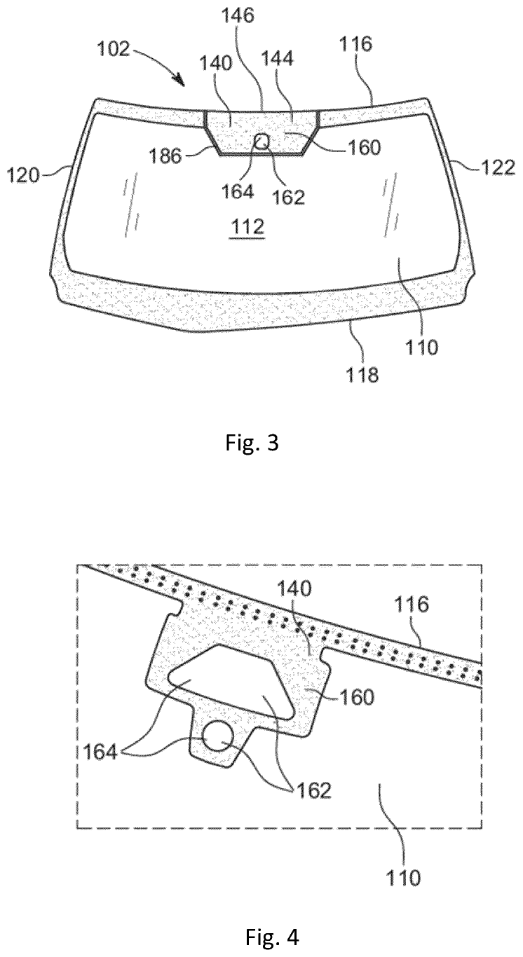

Further, as best shown in FIG. 3, the windshield 102 may include a black print 160 disposed on the insert 140 and covering at least a portion of the insert 140. In the illustrated embodiment, the black print 160 is arranged/disposed on the inner surface 144 of the insert 140. Accordingly, the inner glass layer 150 is sandwiched between the black print 160 and intermediate plastic layer 154. However, it may be envisioned that the black print 160 may either be arranged on the outer surface 142 of the insert 140 or between the plastic layer 154 and the inner glass layer 154. In some embodiment, the black print 160 may be disposed between the outer glass layer 152 and the plastic layer 154. Also, it may be appreciated that the black print 160 is arranged on the inner surface 144 when the insert 140 is made of a single material. As shown in FIG. 4, the black print 160 may define at least one opening 162 that extends through an entire thickness of the black print 160. Accordingly, the at least one opening 162 defines at least one transparent zone 164 for a vision sensor, such as a camera 300, arranged facing the inner surface 144 of the insert 140 to allow a viewing of an ambient by the vision sensor 300.

Additionally, or optionally, as shown in FIG. 5, the windshield 102 (i.e., glazing 100) may include an anti-reflective layer 170 arranged on at least a portion of the inner surface 144 of the insert 140. In some embodiments, the anti-reflective layer 170 is disposed on the area of the inner surface 144 of the insert 140 corresponding to the least one opening 162 (i.e., at least one transparent zone 164) of the black print 160. Further, to prevent an accumulation of water droplets on the insert 140 and maintain a good transparency of the insert 140 during rainy or foggy conditions, the windshield 102 may include a water repellent layer 172 arranged on the outer surface 142 of the insert 140. As the glazing 100 (i.e., windshield 102) is made of two separate components, the water repellent layer 172 may be applied on the insert 140 only, thereby reducing overall cost of the glazing 100 (i.e., the windshield 102).

In some embodiments, again referring to FIG. 1, the windshield 102 may include a bracket 180 arranged facing the inner surface 144 of the insert 140 and having at least one end mounted to the windshield 102. In the illustrated embodiment, a first end 182 of the bracket 180 is mounted to the insert 140 and is located at a junction 186 of the insert 140 with the main body 110, while a second end 184 of the bracket 180 is mounted to the car body 200. However, it may be appreciated that the second end 184 of the bracket 180 may be mounted to the upper edge 146 of the insert 140. Also, in some embodiments, the first end 182 may be mounted to the main body 110 at a location proximate to the junction 186 of the insert 140 and the main body 110. The bracket 180 is adapted to support and house/encase at least one sensor, for example, the camera 300, and other electronics associated with the sensor. The sensor may be a vision sensor, infrared sensor, an ultrasonic sensor, an antenna, an environmental sensor, etc. Additionally, or optionally, the windshield may include a heating element. In some embodiments, the heating elements are thin film heaters embedded inside the insert 140.

A method for manufacturing the windshield 102 is now described. The method includes providing the main body 110 having the inner surface 112, the outer surface 114 and the edge 116 defining the cut-out 126. As shown, the cut-out 126 extends from the upper edge 116 of the main body 110 to the lower edge 118 of the main body 110 and is located substantially centrally of the main body 110 in lateral direction corresponding to a location of the mounting of the rear-view mirror on the windshield 102. Further, the method includes providing the insert 140 having a shape and size identical to that of the cut-out 126. Subsequently, the method includes positioning the insert 140 inside the cut-out 126 such that the upper edge 146 of the insert 140 aligns with the upper edge 116 of the main body 110 and the upper edges 116, 146 together define an upper edge of the windshield 102, and the outer surface 142 of the insert 140 is flush with the outer surface 114 of the main body 110.

Thereafter, the method includes coupling the insert 140 with the main body 110. For so doing, in an embodiment, an adhesive 400 is applied at a junction/interface 186 of the insert 140 and the main body 110 to adhesively couple the insert 140 with the main body 110. The adhesive 400 may be applied by pouring the adhesive at the junction 186. In some embodiments, the insert 140 may be adhesively coupled to the main body 110 by using an adhesive tape 400. It may be appreciated that the adhesive 400 may be selected to have suitable sealing property in addition to adhesion to prevent a leakage of dust, water, and/or moisture through the junction. In some case, the adhesive 400 may be applied by injecting the adhesive 400 at the junction 186. In some embodiment, the adhesive 400 may include silicon to provide vibration damping properties.

In some embodiment, the insert 140 and the main body 110 are coupled to together by injection moulding a thermoplastic elastomer at the junction 186 of the insert 140 and the main body 110. For so doing, a suitable mould that facilitates injection moulding of the thermoplastic polymer, such as, but not limited to polyurethane, rubber, etc, at the junction 186 may be utilized. In an embodiment, silicon may also be utilized for coupling the insert 140 with the main body 110. In some embodiments, the mechanical fasteners may also be used for coupling the insert 140 with the main body 110. In some embodiment, the inset 140 and the main body 110 may include and groove and tongue type configuration to facilitate coupling of the main body 110 and the insert 140.

In some embodiments, the method may also include coupling the bracket 180 with main body 110 and/or the insert 140. For so doing, the bracket 180 is positioned/arranged facing the inner surface 142 of the insert 140 and an end, for example, the first end 182 of the bracket 180 is aligned with the junction 186 of the main body 110 with the insert 140. In some embodiments, the first end 182 is aligned with the junction 186 before attaching the insert 140 with the main body 110. Subsequently, the adhesive 400 or any other suitable material, such as, polyurethane, silicon, thermoplastic polymer, etc., is applied at the junction 186 to couple the insert 140, the main body 110, and the first end 182 of the bracket 180. In some embodiments, the first end 182 is aligned and coupled with the junction 186 after coupling the insert 140 and the main body 110. In some implementations, instead of mounting the first end 182 at the junction 186, the end 182 may be mounted to the main body 110 at a location proximate to the junction 186. Also, other end 184 of the bracket 180 may be mounted to the insert 140, the main body 110, or the car body 200 (as shown in FIG. 1). Additionally, one or more of the black print 160, the anti-reflective layer 170, and the water repellent layer 172 may be applied to the insert 140 before coupling the insert 140 to the main body 110.

In some embodiments, referring to FIGS. 5 and 6, the windshield 102 may include a bracket 180 arranged facing the inner surface 144 of the insert 140 and having at least one end mounted to the windshield 102. In the illustrated embodiment, a first end 182 (=bottom end of the bracket) of the bracket 180 is mounted to the insert 140 and is located at a junction 186 of the insert 140 with the main body 110, while a second end 184 of the bracket 180 is mounted to the car body (200). In this embodiment, the second end 184 of the bracket 180 is mounted to the upper edge 146 of the insert 140. In this embodiment, the first end 182 is mounted onto the main body 110 at a location proximate to the junction 186 of the insert 140 and the main body 110. According to one particular embodiment, the first end 182 of the bracket 180 is mounted onto the main body 110 at a location proximate to the junction 186 of the insert 140, in particular at a distance from 5 to 10 mm from the junction 186 (from the upper or bottom end of the junction). Thus, by extending the position of the first end 182 of the bracket 180 over the main body 110, the strengthen of the junction 186 between the insert and the main body is increased.

According to one embodiment of the present invention, the first end 182 and the second end of the 184 of the bracket 180 are provided with a recess 190. Thus, inside the recess 190, for example a thermoplastic material and more particularly a thermoplastic elastomer material 191 is injected to reach to a soft connection between the insert 140, the main body 110 and the bracket 180. It is understood that any material 191 leading to this “soft connection” may be used.

The bracket 180 is adapted to support and house/encase at least one sensor, for example, the camera 300, and other electronics associated with the sensor. The sensor may be a vision sensor, infrared sensor, an ultrasonic sensor, an antenna, an environmental sensor, etc. Additionally, or optionally, the windshield may include a heating element. In some embodiments, the heating elements are thin film heaters embedded inside the insert 140.

A method for manufacturing the windshield 102 is now described according to one embodiment of the present invention. Further to the steps of providing and coupling/fixing the main body 110 and the insert 140 together as described above, the method comprises a step of strengthening the fixation of the bracket 180 by coupling the bracket 180 with main body 110 and/or the insert 140. For so doing, the bracket 180 is positioned/arranged facing the inner surface 142 of the insert 140 and an end, for example, the first end 182 of the bracket 180 is aligned with the junction 186 of the main body 110 with the insert 140. The end 182 may be mounted to the main body 110 at a location proximate to the junction 186. In a preferred embodiment, the end 182 is mounted from the junction 186 at a distance from 5 to 10 mm onto the main body 110. According to one embodiment of the present invention, the first end 182 and the second end of the 184 of the bracket 180 are provided with a recess 190. Thus, inside the recess 190, for example a thermoplastic material and more particularly a thermoplastic elastomer material 191 is injected or poured to reach to a soft connection between the insert 140, the main body 110 and the bracket 180. It is understood that any material 191 leading to this “soft connection” may be used. The attaching of the bracket may occur after the main body 110 and the insert 140 have been coupled by a material element such as an adhesive 400. Subsequently, the adhesive 400 or any other suitable material, such as, polyurethane, silicon, thermoplastic polymer, etc., is applied at the junction 186 to couple the insert 140, the main body 110, and the first end 182 of the bracket 180. In some embodiments, the first end 182 is aligned and coupled with the junction 186 after coupling the insert 140 and the main body 110.

It is to be noted that the figures and the above description have shown the example embodiments in a simple and schematic manner. Many of the specific mechanical details have not been shown since the person skilled in the art should be familiar with these details and they would just unnecessarily complicate this description. For example, the specific materials used have not been described in detail since it is maintained that the person skilled in the art would be able to find suitable materials to manufacture the glazing (i.e., windshield) according to the current disclosure.

Furthermore, the figures show additional features which the person skilled in the art will be able to understand. As such, they have not been described in detail herein.

1. A glazing, comprising:
a main body (110) having an outer surface (114), an inner surface (112) arranged opposite to the outer surface (114) and an edge defining a cut-out (126) extending from the outer surface (114) to the inner surface (112) of the main body (110); and
an insert (140) having a shape of the cut-out (126), the insert (140) being coupled to the main body (110) and arranged inside the cut-out (126), wherein at least an outer surface (142) of the insert (126) is flush with the outer surface (114) of the main body.

2. The glazing (100) of claim 1, wherein an inner surface (144) of the insert (140) is flush with the inner surface (112) of the main body (110).

3. The glazing (100) of claim 1 further including an anti-reflective layer (170) arranged on an inner surface (112) of the insert (140).

4. The glazing (100) of claim 1 further including a black print (160) arranged on the insert (140), wherein the black print (160) defines at least one opening (162) defining at least one transparent zone (164) for at least one sensor (300).

5. The glazing (100) of claim 1 further including a bracket (180) mounted to the insert (140) to support at least one sensor (300) and arranged facing an inner surface (112) of the insert (140).

6. The glazing (100) of claim 1, wherein the insert (140) is made of an infrared transparent glass.

7. The glazing (100) of claim 6, wherein infrared energy transmissions of the insert (140) and the main body (110) differ by more than 20%.

8. The glazing (100) of claim 1, wherein the insert (140) is adhesively coupled to the main body (110).

9. The glazing (100) of claim 8, wherein an adhesive (400) to couple the insert (140) with the main body (110) is made of a damping material.

10. The glazing (100) of claim 1, wherein the insert (140) is coupled to the main body (110) by injecting a thermoplastic elastomer or a polyurethane material at a junction of the insert and the main body.

11. The glazing (100) of claim 1 further including a water repellent layer arranged on the outer surface (142) of the insert (140).

12. The glazing (100) of claim 1, wherein the glazing is a windshield (102) for a vehicle.

13. The glazing (100) of claim 12, wherein the insert (140) is made of a laminated glass.

14. The glazing of claim 12, wherein
the edge is a first edge (116) of the main body (110) adapted to be arranged proximate to and along a roof of the vehicle, and
the cut-out (126) is defined substantially centrally to the first edge (116), wherein the insert (140) is adapted to support a rear-view mirror of the vehicle.

15. A method for manufacturing a windshield (102), the method comprising:
positioning an insert (140) inside a cut-out (126) of a main body (110) such that an outer surface (142) of the insert (140) is flush with an outer surface (114) of the main body (110), wherein the cut-out (126) is defined by an edge of the main body (110) and extends from the outer surface (114) of the main body (110) to an inner surface (112) of the main body (110); and
coupling the insert (140) to the main body (110).

16. The method of claim 15, wherein coupling the insert to the main body includes applying an adhesive (400) at a junction (186) of the insert (140) and the main body (110) to adhesively couple the insert (140) with the main body (110).

17. The method of claim 15, wherein coupling the insert (126) of the main body (110) includes injection moulding of a thermoplastic elastomer or of a polyurethane material at a junction (186) of the insert (140) and the main body (110).

18. The method of claim 15 further including mounting a bracket (180) to the insert, wherein the bracket (180) is arranged facing an inner surface (112) of the insert (140).

19. The method of claim 18, wherein mounting the bracket (180) includes
positioning an end (182) of the bracket (180) along a junction (186) of the insert (140) and the main body (110), and
coupling the end (182) of the bracket (180) to the junction (186).
